(19) United States
(12) Patent Application Publication
(10) Pub. No.: US 2002/0165993 A1
(43) Pub. Date: Nov. 7, 2002

(54) System and method of partitioning software components of a monolithic component-based application program to separate graphical user interface elements for local execution at a client system in conjunction with remote execution of the application program at a server system

(76) Inventor: Andre Kramer, Cambridge (GB)

Correspondence Address: TESTA, HURWITZ & THIBEAULT, LLP, HIGH STREET TOWER, 125 HIGH STREET, BOSTON, MA, 02110, US

(21) Appl. No.: 09/849,160

(22) Filed: May 4, 2001

(51) Int. Cl. G06F 9/44

(52) U.S. Cl. 709/315

(57) ABSTRACT

Described are a method and system of partitioning software components of a monolithic component-based application program to separate the graphical user interface elements of the software components for local execution at a client system in conjunction with remote execution of the application program at a server system. One or more software components of the application program are identified as a candidate for partitioning. A plurality of new software components corresponding to one of the identified software component candidates is generated at the server system. A protocol to be used by the generated new software components for communicating with each other during an execution of the application program is generated. One of the new software components is transmitted to the client for execution at the client system and for communication with one of the new software components at the server system using the generated protocol when the application program is executed.

### FIELD OF THE INVENTION

The invention relates generally to remote-application processing and multi-user server systems in a networked computing environment. More specifically, the invention relates to a system and method of partitioning software components of a component-based application program for dividing execution of the application program between a client system and a server system.

### BACKGROUND OF THE INVENTION

In a typical computer network, client systems communicate with server systems over communication links. Often a user of the client system formulates and transmits queries to the server system through a user interface operating on the client system. The server system evaluates the queries and transmits responses to the client system for display on the client's user interface.

Over the past decade, a variety of computer networks, such as local area networks (LANs), wide area networks (WANs), Intranets, and the Internet, have adopted remote application processing. In a remote application processing system, all application program execution occurs on the server system, and only the information for controlling the client user interface, keystrokes, and mouse movements travel across the network. Consequently, applications require fewer resources of the client systems to run.

A shortcoming of remote application processing, however, is that the client system may experience an unacceptable round-trip delay (i.e., latency) from when the client system sends input to the server system until the client system receives a response. Such delays can manifest themselves in remote computing environments, such as those encountered on the Internet, WANs, or satellite links, or with multi-user server systems. In remote computing environments, the geographical separation of the client system from the server system produces the delay. This can be particularly troublesome to a user who is typing, for example, at the client system. The time required for the client-user input to travel to the server system and for the server response to return to the client system causes a palpable delay that can confuse the client user and induce typing errors. In multi-user server systems, the round-trip delay may depend more upon the ability of a busy server system, which can be concurrently processing user interface data for multiple active clients, to respond to input received from a particular client system.

Consequently, the benefits of current remote-computing and multi-user technologies are diminished for those implementations where the round-trip response time is greater than the acceptable user interface response time. Thus, there remains a need for a method and system that reduces the delay encountered by the user of a client system in the display of the user interface in remote computing and multi-user computer system networks.

### SUMMARY OF THE INVENTION

One objective of the invention is to provide a method and apparatus for use in remote-application processing and multi-user server system that provides a quick visual response to input to the user of a client system during the execution of an application program. Another objective is to free up network bandwidth by reducing the amount of communication between the client system and the server system over the network. Yet another objective is to free up resources of the server system by having the client system perform some of the execution of the application program, thus increasing the server system's ability to serve greater numbers of clients.

The invention relates to a method and system for executing an application program in a network including a client system in communication with a server system. The invention can operate at design time or run time of the application program. The server system hosts the application program, which is written for execution as a single program unit and includes software components. An application program that is written for execution as a single program unit is written for client-side execution using local graphical user interface (GUI) support from a “fat” client operating system or for server-side execution using remote display. That is, the program developer did not consider distributed execution at the time of developing the application. One or more of the software components of the application program is identified as a candidate for partitioning. A plurality of software components corresponding to one of the identified software component candidates is generated. A protocol to be used by the new software components to communicate with each other during an execution of the application program is generated. One of the plurality of new software components is transmitted to the client system for execution at the client system. The transmitted new software component communicates with one of the other of the new software components at the server system using the generated protocol when the application program is executed. In one embodiment, generating the plurality of software components corresponding to the identified software component includes replicating external interfaces of the identified software component for inclusion in each generated software component.

The identified software component candidate is wrapped in one of the new software components. The wrapped software component can migrate from one new software component to another generated new software component over the network. In one embodiment, the identified software component candidate is wrapped in the new software component that is transmitted to the client system for execution. In this case, the new software components can communicate with each other using a component protocol. In another embodiment, the identified software component candidate is wrapped in a new software component at the server system for execution at the server system. In this case, the new software components communicate with each other using an object protocol.

To facilitate identification of the software component as a candidate for partitioning, the identified software component candidate includes description information (e.g., the types of events that are passed.) Identifying the software component as a candidate for partitioning includes determining that the software component has a software element that relates to a user interface. An example of such a software element is an external interface of the software component.

In one embodiment, generating the plurality of new software components corresponding to the identified software component candidate includes replicating external interfaces of the identified software component candidate for inclusion in each new software component. In another embodiment, analysis of the identified software component candidate determines whether to execute the identified software component candidate at the server system rather than partition the identified software component candidate for execution at the client system.

In another aspect, the invention relates to a method of partitioning a software component for dividing execution of the software component between a client and a server system. A first software component is analyzed to determine whether the first software component is to be partitioned. If the first software component is to be partitioned, a plurality of new software components corresponding to the first software component are dynamically generated. Also generated is a protocol that is to be used by the dynamically generated new software components for communicating with each other. One of the dynamically generated new software components is transmitted to the client system for execution at the client system and for communication with another of the new software components at the server system using the dynamically generated protocol. If the first software component is not to be partitioned, the first software component is executed at the server system communicates with the client system using a remote graphics protocol.

In one embodiment, if the first software component is to be partitioned, a determination is made as to whether the first software component is to execute on the client system. When the first software component is to execute at the client system, the dynamically generated protocol is a component protocol. When the first software component is to execute at the server system, the dynamically generated protocol is an object protocol.

In one embodiment, an integrated development environment is provided in which to analyze the first software component to determine whether the first software component is to be partitioned and to partition the first software component if the first software component is to be partitioned.

In another aspect, the invention relates to a method of executing an application program comprised of a user-interface software component and a non-user-interface software component. A plurality of new software components corresponding to the user-interface software component is generated. The user-interface software component is wrapped with one of the new software components. One of the new software components is transmitted to the client system. Communication with the new software component at the client system uses a dynamically generated protocol when the user-interface software component is executed and communication with the client system uses a remote graphics protocol when the non-user-interface software component is executed.

In yet another aspect, the invention relates to a computer system hosting an application program. A software component analyzer identifies one of the software components of the application program as a candidate for partitioning. A software component generator generates a plurality of new software components corresponding to the identified software component candidate and a protocol to be used by the new software components for communicating with each other over the network. A transmitter transmits one of the new software components to a client system over a network for execution at the client system and for communication with another of the new software components at the computer system using the generated protocol when the application program is executed.

In another aspect, the invention features an application builder tool for providing an integrated development environment in which to construct an application program. The application builder tool includes a software component pallet using a plurality of software components that are available for selection by an application program developer in constructing an application program. A software component splitter generates a plurality of new software components from one of the software components listed by the software component pallet. One of the new software components is generated for execution on a client system and another of the new software components is generated for execution on a server system. The software component splitter generates a protocol to be used by the new software components to communicate with each other.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 is a block diagram of an embodiment of a client system in communication with a server system for executing an application program over a network in accordance with the principles of the invention;

FIG. 2 is a block diagram of an embodiment of a software component splitter of the server system for partitioning software components of the application program into a first software component that executes on the client system and a second software component that executes on the server system;

FIGS. 3A-3C are block diagrams embodying various outcomes of dividing the application program between the client system and the server system and illustrating the communication protocols that can be used by the client and server systems when executing the application program;

FIG. 4 is a flow diagram showing an embodiment of a process used by the server system for partitioning a software component to separate graphical user interface software elements from the application program;

FIG. 5 is a block diagram showing an embodiment of an integrated development environment for partitioning software components and for constructing application programs with partitioned software components; and

FIGS. 6A-6J is a series of screenshots illustrating an example of constructing an application program having a partitioned software component using the integrated development environment.

### DETAILED DESCRIPTION

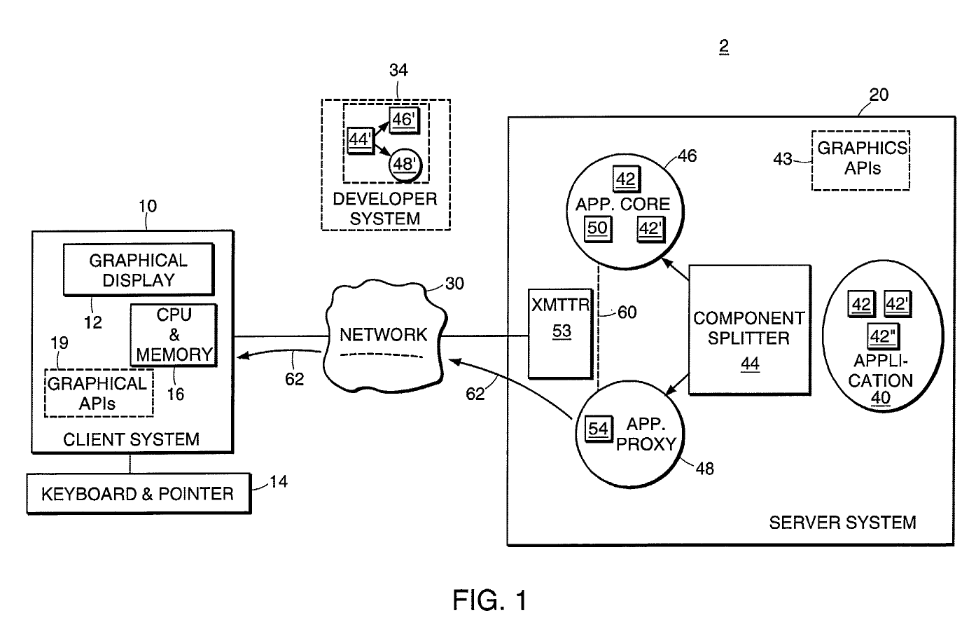

FIG. 1 shows a networked computing environment 2 including a first computing system (client system) 10 in communication with a second computing system (server system) 20 over a communications network 30 to execute an application program 40 hosted by the server system 20. In brief overview, the application program 40 is partitioned into two or more application portions in accordance with the principles of the invention. At least one application portion is transmitted to the client system 10 and at least one other application portion remains on the server system 20. The one or more application portions remaining on the server system 20 execute at the server system 20, and the one or more application portions on the client system 10 execute at the client system 10. Thus, the execution of the application program 40 is divided between the client system 10 and the server system 20. Throughout the execution of the application program 40, the application portion(s) on the client system 10 communicate with the application portions on the server system 20 over the network 30 using a dynamically generated protocol.

The network 30 over which the client and server systems 10, 20 communicate can be a local area network (LAN), Intranet, or a wide area network (WAN) such as the Internet. The client and server systems 10, 20 can connect to the network 30 through a variety of connections including standard telephone lines, LAN or WAN links (e.g., T1, T3, 56 Kb, X.25), broadband connections (ISDN, Frame Relay, ATM), and wireless connections. Connections can be established using a variety of communication protocols (e.g., TCP/IP, IPX, SPX, NetBIOS, Ethernet, RS232, and direct asynchronous connections). Other client and server systems (not shown) may also be connected to the network 30, and the client system 10 and server system 20 can communicate with each other directly or through any number of intermediate computer systems.

The client system 10 can be a personal computer (e.g., 286, 386, 486, Pentium, Pentium II, Pentium III), Macintosh computer, thin-client device, windows and non-windows based terminal, network computer, wireless device, information appliance, RISC Power PC, X-device, workstation, mini computer, main frame computer, or a processor-based device capable of displaying application data in a user interface and of exchanging communications with the server system 20. The client system 10 includes a graphical display screen 12, a keyboard and a pointing device (e.g., a mouse, trackball, touch-pad, touch-screen, etc.) 14, a processor and persistent storage 16.

The user interface displayed on the display screen 12 of the client system 10 can be text driven (e.g., the DOS operating system manufactured by Microsoft Corporation of Redmond, Washington) or graphically driven (e.g., the WINDOWS operating system manufactured by Microsoft Corporation of Redmond, Washington and the X WINDOW SYSTEM™ developed by Massachusetts Institute of Technology of Cambridge, Mass.). For driving the graphical user interface, the client system 10 may include graphical application program interface (API) routines 19, which are typically non-component based.

The operating system of the client system 10 can be one of a variety of platforms including but not limited to WINDOWS 3.x, WINDOWS 95, WINDOWS 98, WINDOWS NT 3.51, WINDOWS NT 4.0, MAC/OS, and Unix, DOS, Linux, and WINDOWS CE for windows-based terminals.

The server system 20 is a computing device that may control access to other portions of the network 30 (e.g., workstations, printers, etc.) and runs application programs in response to input received from the client system 10. Like the client system 10, the server system 20 can support a variety of operating system platforms, such as, for example, WINDOWS 3.x, WINDOWS 95, WINDOWS 98, WINDOWS NT 3.51, WINDOWS NT 4.0, WINDOWS CE for windows-based terminals, MAC/OS, Unix, Linux, WINDOWS 2000, and OS/2. The server system 20 can be a single server system or a group of server systems logically acting as a single server system, called a server farm. In one embodiment, the server system 20 is a multi-user server system supporting multiple concurrently active client systems.

The server system 20 hosts one or more application programs, which the client system 10 can access for execution. Examples of application programs include VISUAL BASIC® COM applications and JAVABEAN applications.

One application program hosted by the server system 20 is the application program 40, which is a component-based software program assembled from a plurality of software components 42, 42′, and 42″ (generally 42). In general, software components are reusable pieces of software (i.e., code) that can be assembled to create an application program. Although comprised of software components 42, the application program 40 is monolithic, that is, the software components 42 are tightly inter-linked to communicate as objects by direct calls (COM) or events (using ActiveX or JAVABEANS event model). In general, a monolithic application program is one developed without consideration for distributed execution of the software components 42 that make up that application program.

When executed, the application program 40 calls application program interface (API) routines to direct the performance of the operating system running on the server system 20. Such APIs include graphics APIs 43 for producing a graphical user interface (GUI) and for driving a display screen or other graphical representation. As described further below, the set of graphics APIs 19, 43 used by the application program 40 to produce the graphical user interface depends upon the particular embodiment of the invention.

Each software component 42 of the application program 40 is a piece of code written in one of a variety of programming languages, such as C, C++, VISUAL BASIC, and JAVA. Each software component 42 includes one or more software elements, such as properties, methods, and events. Properties are named attributes associated with a software component 42, which can be read or written by calling appropriate methods of the software component 42. Methods are procedures that can be called from other software components 42 or from a scripting environment. Events provide a mechanism for software components 42 to notify other software components 42 of the occurrence of certain events. Software elements can be user-interface or nonuser-interface software elements. User-interface software elements produce a visual representation, (i.e., such elements produce a GUI appearance).

34 The framework of each software component 42 in the application program 40 follows a component model, such as JAVABEANS™ developed by Sun Microsystems of Palo Alto, Calif., Object Linking and Embedding (OLE), Component Object Model (COM), Distributed COM (DCOM), ActiveX controls, and the .NET architecture, developed by Microsoft Corporation, and Common Object Request Broker Architecture (CORBA) developed by the Object Management Group (OMG). A software component that follows the JAVABEANS™ component model, for example, is referred to as a JAVABEANS™ component (or a JAVA bean).

Each software component model specifies the framework for defining the software elements of and the interactions between the software components 42 so that a software designer can assemble an application program using such software components 42. More specifically, the framework defines the external interfaces of the software components 42, such as the external (or public) methods, properties, event registration and delivery mechanisms, and component and inter-component linkage descriptions, which the software component 42 exposes (i.e., is publicly accessible to other software components). Another linkage is an array or compound property. Linkages list which software component 42 holds an object reference to another software component 42 (for public calls) and which event listeners are attached to a particular software component 42.

The application program 40 also includes description information for the external interfaces of the software components 42. For example, application program developers developing JAVA beans can explicitly list the public description information about these JAVA beans by creating a bean information class that specifies various information about a JAVA bean, such as a property list, a method list, and an event list. In one embodiment, the underlying component model of the software components 42 defines the nature (e.g., content) of such description information by employing a component model design pattern, naming convention, or design-time component descriptors. Design patterns are conventional name and type signatures for sets of methods and interfaces (e.g., “get” and “set” methods). Another useful application linkage description is how the linkages are used to inter-connect the software components 42. This linkage description can be learned as the application program 40 is assembled in an integrated development environment (IDE), or by static analysis of the software components 42 (e.g., by looking at what objects create other objects, and which objects have properties or variables holding references to other software components.)

As an example, the JAVABEANS™ component model for the JAVA object-oriented programming language provides the external interface descriptions in descriptor objects, or, by default, through JAVA class type information. For example, an application program developer can provide a BeanInfo class that describes the software component (i.e., JAVA bean), which can then be used to discover the behavior of that software component. Also, the component model may provide an Introspector class that understands the various design patterns and interfaces. The Introspector class enables uniform introspection (described further below) of different software components. At design-time, a software programmer can incorporate other types of description information not specifically called for by the underlying component model but useful in identifying the nature of the software components. As another example, the Active Accessibility API, developed by Microsoft Corporation of Redmond, Washington, models user interface elements as Component Object Model (COM) objects. A client user is able to examine a COM object using provided functions such as IAccessible::accLocation and IAccessible::get_accName. These foregoing examples are intended to be illustrative and not exhaustive.

The description information is available at run-time of the application program 40 or at design time (e.g., when the application program developer is constructing the application program from software components using an IDE). In accordance with the principles of the invention, the description information is used for identifying whether a given software component 42 is a candidate for partitioning. An application program developer can manually (through an application builder tool) or automatically (using software) examine the description information through a process called introspection. Introspection is used to determine the properties, events, and methods supported by a given software component 42. In one implementation, the introspection process includes analyzing the methods supported by the software component 42 and then applying design patterns to deduce the properties, events, and public methods that are supported.

The server system 20 also includes a software component splitter 44, which, in accordance with the principles of the invention, divides the application program 40 into at least two application portions: an application core 46 and an application proxy 48. The application core 46 corresponds to a portion of the application program 40 that executes at the server system 20. The application proxy 48 corresponds to a portion of the application program 40 that the server system 20 transmits to the client system 10 for execution at the client system 10. A transmitter 63 of the server system 20 transmits (arrow 62) the application proxy 46 to the client system 10 over the network 30. This transmission can occur in response to the client user launching the application program 40 from the client system 10. Thus, the invention operates to move part of the execution of the application program 40 from the server system 20 to the client system 10.

More specifically, the software component splitter 44 receives the application program 40 (or one or more software components 42) as input and analyzes the input to identify candidates for partitioning. An example of a candidate for partitioning is a software component 42 that has a user-interface software element. Software components 42 that are not candidates for partitioning are not partitioned and become part of the application core 46. For each software component candidate that satisfies a predetermined criterion, such as requiring that the software component have a user-interface element, the software component splitter 44 partitions that software component 42 by producing at least two new software components 50, 54 related to that software component 42. The new software component 50 becomes part of the application core 46 and the new software component 54 becomes part of the application proxy 48. The new software components 50, 54 in combination substitute for the original, partitioned software component 42 in the application program 40. Accordingly, the application core 46 includes non-partitioned software components 42 and new software components 50; the application proxy 48 includes new software components 54 each corresponding to one of the new software components 50 of the application core 46.

For example, in FIG. 1, software components 42, 42′ are non-partitioned, and thus become part of the application core 46, whereas software component 42″ is partitioned, and is substituted for by two new software components 50, 54. New software component 50 becomes part of the application core 46 and new software component 54 becomes part of the application proxy 48.

The software component splitter 44 also generates a protocol 60 by which the new software components 50, 54 communicate. For example, consider a GUI software component 54 that is sent to the client system 10 (because of partitioning). This GUI software component 54 may raise an event (e.g., in response to user input) to another software component 42. An event handler on the client system 10 is associated with the GUI software component 54. In one embodiment, this event handler is dynamically generated along with the protocol 60 and sent to the client system 10. In other embodiments, rather than be dynamically generated, the event handler can be configured, by setting a “forward address” property on an event handler component at the client system 10 (i.e., a JAVA bean with settable properties as an event handler component). The event handler intercepts the raised event and marshals the event for network transmission. The dynamically generated protocol 60 sends the marshaled event to the server system 20, and the protocol 60 on the server system 20 forwards the event to the target software component 42.

As another example, consider a software component 42 on the server system 20 setting a property on GUI software component of the application program 40. For example, the property could be a label on a graphical button. Instead, the software component 42 communicates with an appropriate software component 50 of the application core 46. This software component 50 in the application core 46 uses the protocol 60 to forward the property change to the client system 10. The protocol 60 at the client system 10 forwards the property change to the corresponding GUI software component 54 of the application proxy 48. The client system 10 operates as an execution environment, virtual machine, or “player” for the application proxy component 54 as the proxy component 54 executes in a software container on the client system 10. For example, the proxy component 54 can be a JAVA applet or JAVAScript running in a browser on the client system 10. Here, to support execution of the proxy component 54, the client system 10 provides the client operating system and the web user interface environment. Thus, during the execution of the application program 40, the new software components 50, 54 interact over the network 30 using the generated protocol 60 as described in more detail below.

In one embodiment, if the analysis of the input does not identify any software component candidates for partitioning, or if the analysis shows that partitioning is possible but not expedient for the application program 40, the software component splitter 44 does not generate the application core 46 and the application proxy 48. In this case, the application program 40 executes on the server system 20 in its entirety as originally designed.

The networked computing environment 2 can also include a program development system 34 (shown in phantom). The program development system 34 includes an application builder tool 18 for developing application programs in accordance with the principles of the invention. The application builder tool 18 is a set of integrated software tools (i.e., a tool chain) that is generally run from the user interface and which provides an integrated development environment in which to develop application programs. The application builder tool 18 includes a component splitter 44′ that produces an application core 46′ and application proxy 48′ as described above.

During operation in the networked computing environment 2, the client system 10 communicates with the server system 20 to execute the application program 40 hosted by the server system 20. User input supplied at the client system 10 serves as input to the application program 40. Examples of user input, typically submitted by a user of the client system 10, include characters entered through the keyboard 14 or cursor movements submitted using the pointing device 18.

In standard remote computing or multi-user computing environments, execution of the application program 40 occurs on the server system 20 as directed by the user input sent to the server system 20 from the client system 10. In response to the user input, the server system 20 produces a server response that controls the content and appearance of the screen display of the client system 10 when subsequently transmitted to and received by the client system 10. The type of the server response depends on the type of the user input received and the application program that is processing the user input. The period of elapsed time for the user input to traverse the network 30 to the server system 20 and for the server response to return to the client system 10 is the latency of the connection between the systems 10, 20. When the client system 10 and server system 20 are communicating over a highlatency connection, the client user may experience a palpable delay from the moment of entering the input until the moment of receiving a server response. Such high-latency connections are common in a WAN or Internet environment and can occur in multi-user computer systems that are busy responding to queries from multiple active clients.

In contrast to such standard remote computing and multi-user computing environments, remote computing and multi-user computing environments embodying the principles of the invention divide the execution of the monolithic application program 40 between the client system 10 and the server system 20. In particular, during the execution of the application program 40, the application core 46 executes on the server system 20 and communicates with the application proxy 48, which resides and executes on the client system 10. More specifically, the new software components 50 of the application core 46 communicate with the new software components of the application proxy 54 using the dynamically generated protocol 60.

During execution of the application core 46 at the server system 20, each new software component 50 of the application core 46 intercepts program interactions with certain software elements (e.g., user-interface elements) of that new software component 50 and can transmit the interactions to the corresponding new software component 54 of the application proxy 48 on the client system 10. The new software component 54 of the application proxy 48 responds to the intercepted program interactions locally at the client system 10. Some events can be processed locally at the client system 10 if the software components affected by the events have been moved to the client system 10. For example, if a scroll bar component and a list component associated therewith are moved to the client system 10, any interactions with the scroll bar can be processed at the client system 10 without having to send event information over the network 30.

The new software component 54 of the application proxy 48 intercepts user input (e.g., keyboard strokes, mouse clicks) that interacts with certain software elements (e.g., user-interface elements) of the new software component 54 and responds to such user input locally without having to forward such user input to the server system 20. When the intercepted user input interacts with user-interface software elements of the partitioned software component 54 of the application proxy 48, the local response produces an immediate response on the client's user interface. Any delayed response caused by latency associated with the round-trip communications between the client and server systems 10, 20 is thereby avoided. Further, this local execution of a portion of the application program 40 consequently frees resources of the server system 20, which does not need to respond to user-interface-related user input. Also, the local execution uses less network bandwidth than if the application program 40 executed entirely on the server system 20 because the user-interface-related client user-input and resulting user information do not traverse the network.

With respect to client-user-input that interacts with non-user-interface software elements, the client system 10 transmits such input over the network 30 to the server system 20 to be processed by the appropriate non-partitioned software component 42 or new software component 50 of the application core 46.

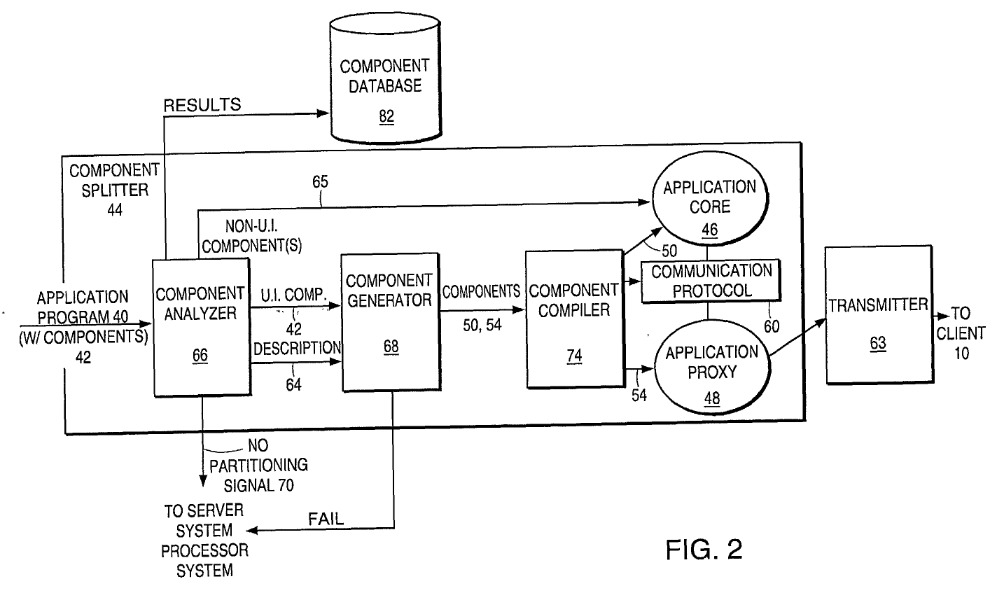

FIG. 2 shows an embodiment of the software component splitter 44 in communication with the transmitter 63 and with a software component database 82. The software component splitter 44 includes a component analyzer 66, a software component generator 68, and a software component compiler 74. In another embodiment, the software component splitter 44 does not comprise the component analyzer 66. The component analyzer 66 receives the component-based application program 40 as input and determines for each software component 42 of the application program 40 whether that software component 42 is to be partitioned.

By inspecting the description information included in the application program 40, the component analyzer 66 searches for and identifies software components 42 that have a software element that satisfies a predetermined criterion. In the following description, the predetermined criterion for identifying a software component as a candidate for partitioning is that the software component 42 includes a software element that produces a visual presentation (i.e., user-interface elements). Software components 42 that satisfy this criterion are hereafter referred to as user-interface software components and those that do not, as non-user-interface software components. Other criterion can be used to practice the principles of the invention (e.g., software components that process user input).

In the present embodiment, the software component splitter 44 partitions user-interface software components, adding non-partitioned software components 42 and new software components 50 (see arrow 65) to the application core 46 and corresponding new software components 54 to the application proxy 48. Although shown in FIG. 2 to pass directly to the application core 46, the non-user-interface software components 42 are compiled before becoming part of the application core 46.

The principles of the invention apply to a variety of GUI software components, such as JAVA AWT and Swing components and those components derived therefrom (by object-oriented inheritance, for example). Other examples are Win GUI controls and Motif Widgets. Further, user interfaces that use a “model-view-controller” design pattern can also be supported. The view represents presentation (how the user interface is drawn), control is how input is processed (i.e., how events affect data), and the model is the abstract data (e.g., a telephone list shown in a scrollable, selectable list. Selecting an item in the list, for example, with a mouse click, is the control that tells the application which number to dial.) The “view” can be partitioned from the “model” and “control” aspects of the user interface.

The component analyzer 66 stores the results of the analysis and description information in the component database 82, which accumulates such results from analyses performed over time. The analysis results and description information stored in the database 82 facilitate partitioning other application programs that use some of the same software components 42 as the application program 40. The database 82 also can facilitate partitioning the same application program 40 during subsequent launchings of the application program 40 by the same or a different client user.

In one embodiment, the component analyzer 66 examines the software components 42 automatically (i.e., through software) using introspection at the language level, component model level, or both to identify candidates for partitioning. As part of the identification process, the component analyzer 66 determines whether any user-interface software components 42 map directly to built-in client display capabilities (e.g., client-component libraries and graphics APIs). The server system 20 can ask for the client display capabilities when the client system 10 connects to the server system 20. The component analyzer 66 selects for partitioning those user-interface software components 42 that can make use of client display capabilities. Such user-interface software components 42 are forwarded to the component generator 68, along with any description information 64 that has been provided with the application program 40 and associated with those user-interface software components 42. Preferably, the client system 10 supports the same component model as the server system 20 and has the same graphics API. In other embodiments, the principles of the invention apply across system platforms by remoting heterogeneous proxy components 54 to the client system 10.

The component analyzer 66 can determine that some software components 42 of the application program 40 are not good candidates for partitioning. For example, partitioning may be implausible because of incompatibility between the software components 42 and the underlying component model, or impractical because partitioning the software components 42 does not make any appreciable improvement in the performance in the application program 40. In the latter instance, the component analyzer 66 determines to keep all execution of the application program 40 at the server system 20, although one or more software components 42 of the application program 40 satisfy other criteria for partitioning. The component analyzer 66 issues a “no partitioning” signal 70 instructing the processing system of the server system 20 to cease attempting to partition the application program 40 and to keep all execution of the application program 40 at the server system 20.

In one embodiment, the component analyzer 66 determines whether to partition the application program 40 on a software component by software component basis (i.e., partitioning some software components, while not partitioning others). The decision to remote one software component can influence the decision to remote another software component. For example, a scroll bar component may interoperate with a list component. If both scroll bar and list components are remoted (i.e., transmitted remotely) to the client system 10, then user input on the scroll bar can be locally processed. Thus, the decision to remote the scroll bar component can influence a decision to remote the list component.

In another embodiment, the component analyzer determines whether to partition the application program 40 as a whole (i.e., not partitioning any software component 42, although one or more software components 42 satisfies the criterion for partitioning).

When all execution of the application program 40 occurs at the server system 20, the server system 20 transmits the user-interface information, such as windows application screen presentation, full-screen text presentation, and keyboard and pointing device updates produced as a result of such execution, to the client system 10 using a remote graphics protocol (or presentation services protocol). One example of a remote graphics protocol is the Independent Computing Architecture (ICA) protocol developed by Citrix Systems, Inc. of Ft. Lauderdale, Fla. The ICA protocol controls the input/output between the client system 10 and server system 20. The design of ICA is for the presentation services to run over industry standard network protocols, such as TCP/IP, IPX/SPX, or NetBEUI, using industry-standard transport protocols, including but not limited to ISDN, frame relay, and asynchronous transfer mode (ATM). Other embodiments can employ other windowing system remoting technologies for the remote graphics protocol, such as MICROSOFT RDP (Remote Desktop Protocol) and X Server.

When the component analyzer 66 identifies a software component 42 for partitioning, the software component generator 70 generates a first new software component 50 for the application core 46, a second new software component 54 for the application proxy 48, and the protocol 60 by which the newly generated software components 50, 54 communicate with each other. The software component generator 70 gives each new software component 50, 54 the same external interfaces as the original software component 42 that the analyzer 66 identified for partitioning. One of the newly generated software components 50, 54 encapsulates (i.e., wraps) the original software component 42, which includes presentation logic (i.e., the binary code driving the graphical presentation that appears on the user interface). The newly generated software component 50, 54 that wraps the original software component 42 prefaces and initiates execution of that original software component 42 when the flow of execution of the application program 40 calls for such execution.

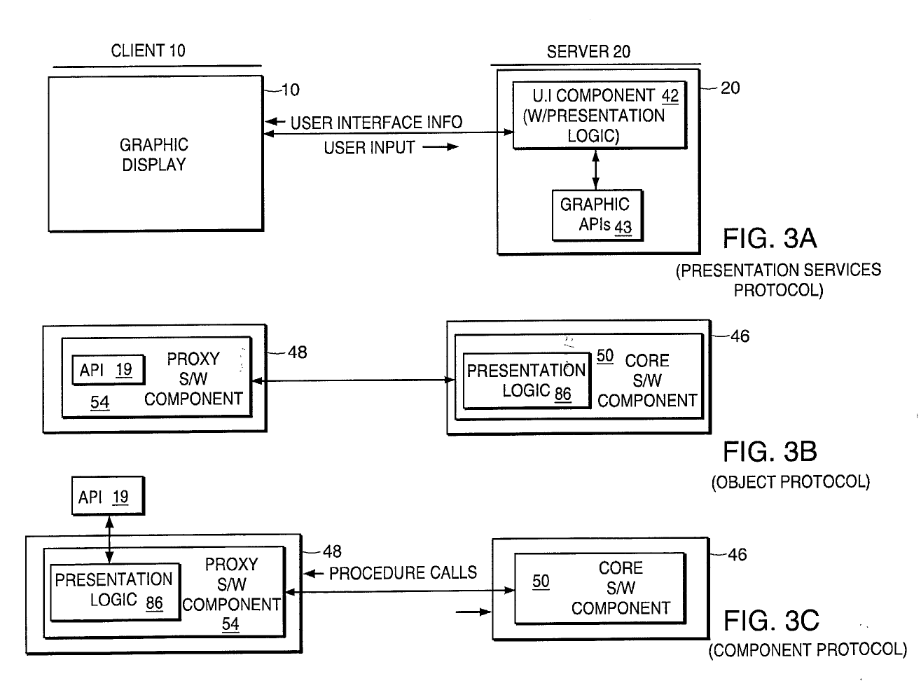

The software component analyzer 66 also determines which of the new software components 50, 54 wraps the original software component 42. This determination also determines the type of protocol 60 generated by the software component generator 70 and used by the new software components 50, 54, as described further below in connection with FIGS. 3A-3C. If the underlying component model supports software component mobility the original software component 42 can migrate from one newly generated software component 50, 54 to another newly generated software component 54, 50 during the execution of the application program 40. In component mobility, a software component that is created and initialized on one system 10, 20, is moved (including its internal state) to another system 20, 10 during application execution.

If unable to generate the software components 50, 54 from the original, candidate software component 42, the software component generator 70 issues a “fail” signal to the processing system of the server system 20. As a result, the attempt to partition the original software component 42 ceases. Consequently, execution of this software component 42 in its entirety remains at the server system 20, and the server system 20 transmits any user-interface information generated by executing the software component 42 to the client system 10 using the remote graphics protocol described above. For example, standard Ul components (labels, lists, buttons, and scroll bars) are easy to remote to the client system 10 compared to customized, arbitrary Ul widgets (e.g., a stick insect editor that writes directly to text files or a computer-aided design system component for automobile engineering), which are generally difficult to split and therefore can be left on the server 20.

From the software component generator 70, the generated software components 50, 54 pass to the software component compiler 74. The compiler 74 compiles the components 50, 54 to produce a dynamically linkable, binary representation (i.e., executable code) of software components 50, 54 for inclusion in the application core 46 and the application proxy 48, respectively.

The transmitter 63 transmits the software components 54 of the application proxy 48 to the client system 10 over the network 30, incrementally or all together at a single transmission. Transmission occurs as each software component 54 of the application proxy is needed for execution or in advance of such need.

In one embodiment, the invention can be used to emulate component mobility. Copies of a software component 54 in the application proxy 48 are stored at the client and the server systems 10, 20. During runtime, the application program 40 execution can dynamically switch between using the proxy component 54 at the server system 20 to the proxy component 54 at the client 10. (A switch in the other direction is also possible.) The proxy components 54 can be selectively instantiated at run-time to achieve the component mobility.

The proxy component 54 can be migrated at an arbitrary time after the start of application program 40 execution. The protocol 60 supports the switch over. Thus, server side execution of the proxy component 54 ceases, and the proxy component 54 is transmitted and established at the client system 10. The dynamically generated protocol 60 needs to know whether proxy component 54 is at the server system 20 or has been remoted to the client system 10. In such a scheme, the application program 40 starts execution on the server system 20 (using the remote graphics protocol), and components 42 are incrementally partitioned and downloaded to execute on the client system 10. Proxy components 54 control the switch over to the object or component protocol. Initially a proxy component 54 does local calls on the server system 20, then switches to the object or component protocol after an up-to-date copy of the software component 54 is at the client 10.

FIGS. 3A-3C are block diagrams illustrating the various embodiments of protocols that the client and server systems 10, 20 can use to communicate with each other during the execution of the application program 40. The various embodiments include a remote graphics protocol, a dynamically generated object protocol, and a dynamically generated component protocol. Network communication using the dynamically generated protocols (i.e., the object and component protocols, described further below) occur at a higher level than the remote graphics protocol. For example, at the object or component level, typed method calls, logical property updates (set color green) or events (mouse double click for item selection) are at a higher level than low level instructions such as “color pixel at x, y with current paint,” or “mouse left button down, up, down.” As another example: “change the label of the button” is at a higher level than “write text at location x, y using font 12. Communication with the remote graphics protocol is more network bandwidth intensive than with each of the dynamically generated protocols because by the remote graphics protocol the client system 10 sends all user input to the server system 20 and the server system 20 returns the resulting user-interface over the network 30. Whereas for the dynamically generated protocols, the client system 10 processes the user-interface-related user input and produces the user-interface information locally.

FIG. 3A shows the client system 10 in communication with the server system 20 using a remote graphics protocol such as ICA described above. Here, in response to user input, user-interface software components 42 execute on the server system 20, calling the graphics APIs 43 residing at the server system 20. Execution of the graphics APIs 43 produces user-interface information, which the server system 20 transmits over the network 30 for presentation on the graphics display of the client system 10 using the remote graphics protocol.

FIG. 3B shows a software component 54 of the application proxy 48 at the client system 10 in communication with a software component 50 of the application core 46 at the server system 20 over the network 30 using a dynamically generated object protocol. The object protocol is used when the partitioning of a given user-interface software component 42 is designed to take advantage of graphics capabilities of the client system 10. In these instances, the software component 54 of the application proxy 48 that is dynamically generated from the original software component 42 and transmitted to the client system 10 wraps one of the graphics APIs 19 of the client system 10.

The presentation logic 86 of the original user-interface software component 42 remains at the server system 20 within the corresponding dynamically generated software component 50 of the application core 46. Execution of presentation logic 86 occurs at the server system 20, and the server system 20 remotes the resulting display using the object protocol to drive the wrapped graphics API 19 on the client system 10 through the corresponding software component 54 of the application proxy 48. Thus, the software components 50, 54 that substitute for the original partitioned component communicate with each other. Such communication can be considered intra-component in the sense that the communication is entirely within the original partitioned application component 42 (i.e., between the newly generated software components 50, 54), and does not involve any other original application component 42 (or core or proxy components 50, 54 generated from such other original application component 42).

In one embodiment, the object protocol is pre-generated (developed beforehand rather than dynamically generated) and stored in the database for a particular widget set (i.e., a library of GUI components).

In the object protocol, messages have meaning at the interface of the software component 42: method calls, property “set” and “get,” and events (in contrast to low level graphics). In the object protocol, the partitioned component 42 is replaced with a logically equivalent component 50 that uses high-level messaging to remote its internal effects. A property change (e.g., set background color) is intercepted by the replacement component 50 and is remoted to the client system 10 as a high level change (e.g., to set the color of a remote representation of the object).

In one embodiment, the object protocol is implemented using JAVA IDL (Information Definition Language), which is an object request broker (ORB) provided with the JAVA 2 platform. Object request brokers are software technology that manages communication and data exchange between objects. ORBs enable application program developers to construct application programs by assembling objects that communicate with each other via the ORB. Specifically, JAVA IDL are a set of APIs written in the JAVA programming language for defining, implementing, and accessing CORBA (Common Object Request Broker Architecture) objects.

FIG. 3C shows a software component 54 of the application proxy 48 at the client system 10 in communication with a software component 50 of the application core 46 at the server system 20 over the network 30 using a dynamically generated component protocol. In the component protocol, the user of the component (i.e., the caller) rather than the component object is modified. The component object resides on the client system 10 and interaction with the component object is remoted from the server system 20. In effect, a remoting layer is placed below the client side component and the application program 40 on the server system 20. Communication is intercomponent, that is, between server-side application components 42 and 50 and clientside application components 54. The component protocol is dynamically generated for each application component encountered during analysis of the application program 40. Events generated by the client-side components 54 during execution of the application program 40 are captured and forwarded to the application components 42 and 50 on the server system 20.

In one embodiment, the component protocol is implemented using JAVA RMI (Remote Method Invocation), which is a mechanism analogous to RPC-type (remote procedure call) protocols. The dynamically generated software component 54 of the application proxy 48 at the client system 10 includes the presentation logic 86 of the original software component 42 upon which that software component 54 was based. The corresponding software component 50 of the application core 46 at the server system 20 intercepts calls to execute the original software component 42 and remotes such calls to the corresponding software component 54 of the application proxy 48 over the network using the component protocol. The software component 54 of the application proxy 48 executes the wrapped presentation logic 86 at the client system 10, which calls the appropriate graphic APIs 19 to drive the display on the client system 10.

Keeping the processing of the presentation logic local to the client system 10 saves network bandwidth as the graphic APIs 19 are driven locally and not remotely from the server system 20. With the presentation logic downloaded to the client system 10, only interactions with non-user-interface software components need to traverse the network 30. Often these interactions have lower bandwidth requirements or lesser timeliness constraints than user-interface software component interactions.

User-interface interactions, such as keyboard or mouse input processing, can be handled locally at the client system 10. The local processing avoids round trips to the server systems 20. Thus, the network 30 is not involved. This means that execution of the application program 40 is less sensitive to network latency or latency variance (i.e., jitter), which makes for a better client user experience.

During execution of the application program 40, the client and server systems 10, 20 can communicate using any one or combination of the remote graphics, object, and component protocols, depending upon the results determined by the component analyzer 66 for each software component 42 of the application program 40 and the underlying component model of each software component 42. For example, the client and server systems 10, 20 can communicate using a remote graphics protocol to display an initial user interface at the client system 10. Then the client and server systems 10, 20 can switch to communicating using an object or component protocol after the server system 20 transmits the application proxy 48 to the client system 10.

As another example, one application core software component 50 can communicate with a corresponding application proxy software component 54 using a remote graphics protocol, while another application core software component 50 communicates with its corresponding application proxy software component 54 using an object protocol, and yet another application core software component 50 communicates with its corresponding application software component 54 using an component protocol. Here, in the first two instances, the remoting is internal to one application component 42 (the original partitioned component 42). In the first instance, the application component communicates with the client GUi APIs using low level graphics via a “remoting layer” that translates GUI calls to the remote graphics protocol, such as ICA. In the second instance, the application component internally communicates with a remote client-side Ul proxy component (a remoted GUI component 54) by RPC remote calls (i.e., a fixed, pre-generated object protocol) to specific client-side GUI component objects. In the third instance, the remoting is between the server-side application component 50 and client-side application components 54, requiring a dynamically generated component protocol.

As described above, the object and component protocols can be implemented using RPCs. As an optimized implementation, these protocols can use asynchronous or one-way communications to avoid blocking (i.e., waiting for a reply to the RPC) where possible. RPCs with null or void replies, or CORBA asynchronous RPCs, can be used to achieve non-blocking remote calls.

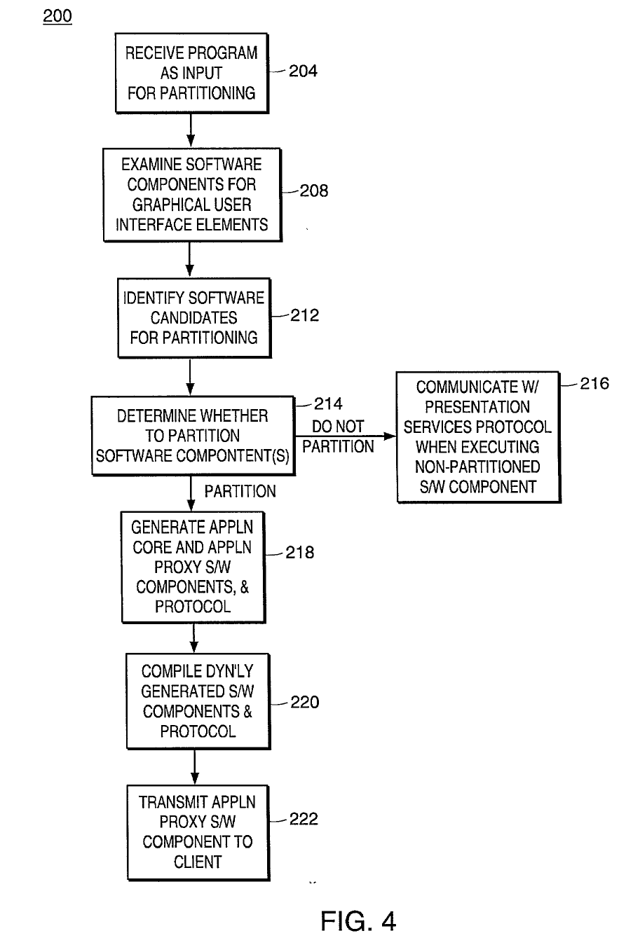

FIG. 4 shows an embodiment of a process 200 performed by the server system 20 for dividing execution of the application program 40 between the client and server systems 10, 20. The server system 20 can automatically perform the process 200 in response to a request to execute the application program 40 or in preparation for executing the application program 40 (e.g., at design time of the application program 40). In another embodiment, the application program developer can perform the process 200 through the application builder environment 18 at the development system 34. The partitioning process 200 can employ a copy of the application program 40 so that the original application program 40 is unaltered by the process 200. Although the subsequent description of the partitioning process 200 is with respect to partitioning user-interface software components 42, the principles of the invention apply to the partitioning of other types of software components.

The software component splitter 44 receives (step 204), as input, a highlevel language version (e.g., source code) of the component-based application program 40. In other embodiments, some of the software components are available as binary objects (still introspectable and with suitable descriptions), such as serialized JAVA objects or beans. In this case, a modified IDE 18 is used to assemble the application program 40, provided the IDE 18 can record how the application components are linked to each other. Thus, the component splitter 44 can process source and binary objects with browseable descriptions and IDE linkages. The component analyzer 66 examines (step 208) the descriptions of the external interfaces of the software components 42 of the application program 40. Such descriptions indicate whether any of the software elements (i.e., the external methods, properties, event registrations) of a given software component 42 are associated with producing a graphical (i.e., visual) appearance.

From the examination of the external interfaces, the software component analyzer 66 identifies (step 212) software components 42 with software elements of interest that can be partitioned from the application program 40. In this embodiment of the process 200, the software elements of interest are component elements that relate to the user interface or presentation logic. If the software component analyzer 66 determines (step 214) that the software components 42 of the application program 40 cannot or should not be partitioned, these non-partitioned software components 42 execute on the server system 20 in their entirety. The non-partitioned software components 42 can include user-interface software components that the component analyzer 66 determined should not be partitioned although such components contained software elements of interest. When executing such non-partitioned user-interface software components 42, the client and server systems 20 communicate (step 216) using a remote graphics protocol.

If the software component analyzer 66 determines to partition a given software component 42 of the application program 40, the software component generator 70 generates (step 218) a software component 50 for the application core 46, a software component 54 for the application proxy 48, and the protocol 60 by which the software components 50, 54 communicate over the network 30. The software component generator 70 also wraps the given software component 42 within one of the newly generated software components 50, 54. If the component analyzer 66 determines that the presentation logic 86 remains at the server system 20, the component generator 70 wraps the given software component 42 with the application core software component 50, and the protocol 60 used to communicate between the software components 50, 54 is an object protocol. If instead the component analyzer 66 determines that the presentation logic 86 is to execute at the client system 10, the component generator 70 wraps the given software component 42 with the application proxy software component 54, and the dynamically generated protocol 60 used to communicate between the software components 50, 54 is a component protocol.

The software component compiler 74 compiles (step 220) the software components 50, 54 of the application core 46 and application proxy 48, and the associated protocol 60. The transmitter 63 of the server system 20 transmits (step 222) the application proxy 48 to the client system 10 over the network 30, while the application core 46 remains on the server system 20. The server system 20 can send the compiled software components 54 of the application proxy 48 to the client system 10 as each software component 54 is needed for execution or in advance of such need. The results produced at each of the steps 208, 212, 214, and 218 can be stored in the database 82. Client systems 10 can also reference the database 82 as a shared code repository or could cache a portion of the database 82 to avoid repeated downloads of the same software components 54.

The database 82 can augment one or more of the steps of process 200. For example, the software component splitter 44 can access the database 82 to obtain a history of which software components have been analyzed in the past and recorded within the database 82. Thus, instead of having to examine external interfaces (step 208), identify partitioning candidates (steps 212 and 214), and/or generate new software components 50, 54, the software component splitter 44 can obtain such information from the database 82. Conversely, the results produced by any of the steps of the process 200 can be stored in the database 82 for future reference.

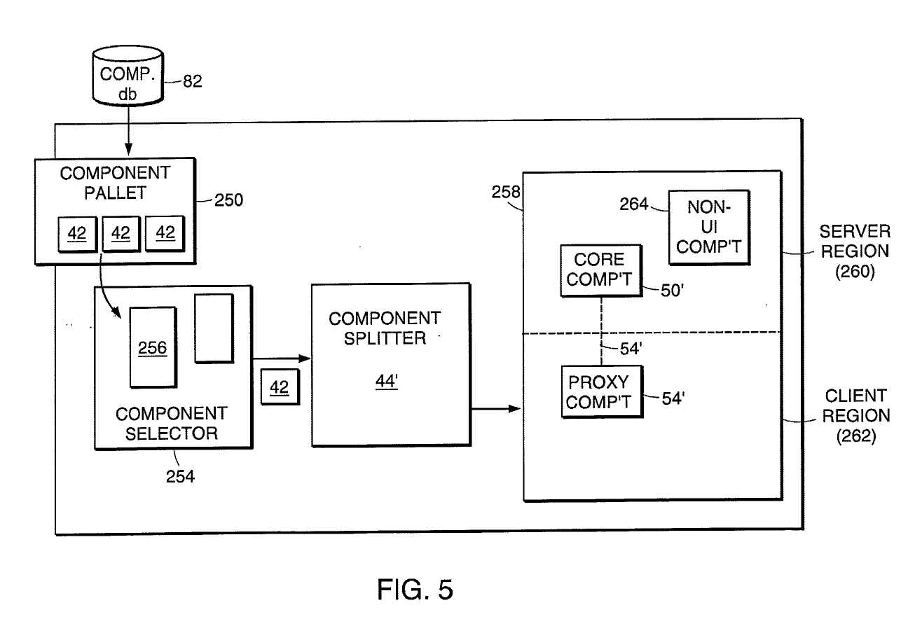

FIGS. 5 shows an example of the IDE produced by the application builder tool 18, which an application program developer can use to construct an application program in accordance with the principles of the invention. The application builder tool 18 incorporates a software component splitter 44′ and provides the designer with a visual interface through which the application program developer interactively directs the partitioning of software components during the construction of the application program. Executing the application builder tool 18 displays a plurality of visible graphical windows on the display screen of the application program developer. The displayed graphical windows include a component pallet 250, a component selector 254, and a design region 258. The design region 258 has two regions: a server system design region 260 and a client system design region 262. A purpose of the split of the design region 258 into two regions 260, 262 is to assist the application program developer in understanding the component partitioning process.

The component pallet 250 lists various software components 42 that are available for selection by the application program developer in the construction of the application program. Such software components 42 can be in pre-processed and stored in the component database 82. For example, JAVA AWT (i.e., a standard graphics toolkit for platform-independent JAVA graphics) components are JAVA beans that are candidates for pre-processing and storing in the database 82.

The component selector 254 displays description information (e.g., what events are passed) about the software components 42 selected by the application program developer from the component pallet 250 for constructing the application program. From the description information, the application program developer determines whether the selected software component 42 contains a software element that can be partitioned from the software component 42. Software components 42 chosen for partitioning pass to the software component splitter 44′.

In the IDE embodiment, the input to the software component splitter 44′ is individual software components, rather than a complete application program. The software component splitter 44′ operates on each selected software component 42 like the software component splitter 44 described in FIGS. 1-4. The results produced by the software component splitter 44′ are displayed in the design region 258. For example, as shown in FIG. 5, an application core software component 50′ appears in the server system design region 260, a corresponding application proxy software component 54′ appears in the client system design region 262, and a protocol 60′ links the software components 50′, 54′. Also, non-partitioned software components (e.g., non-UI component 264) appear in the server system design region 262.

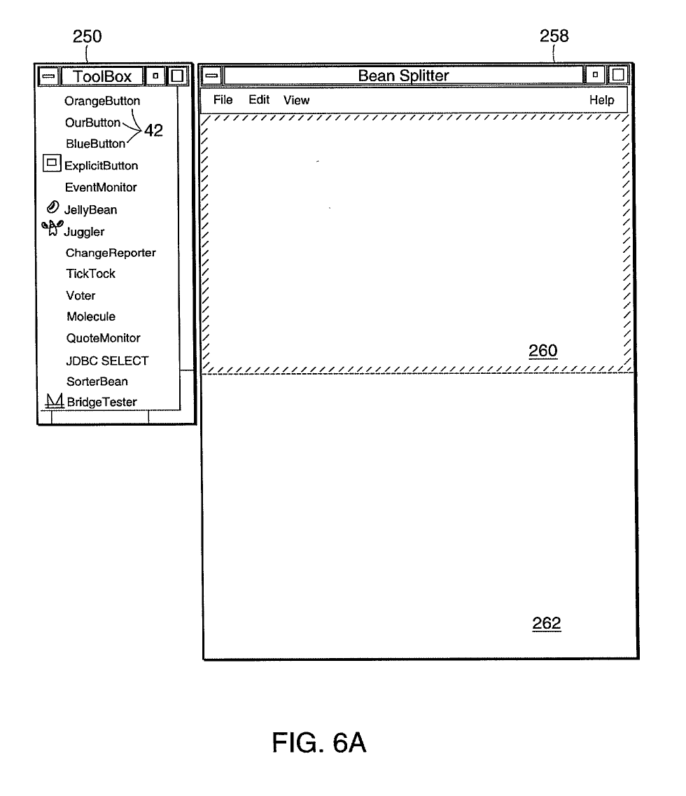

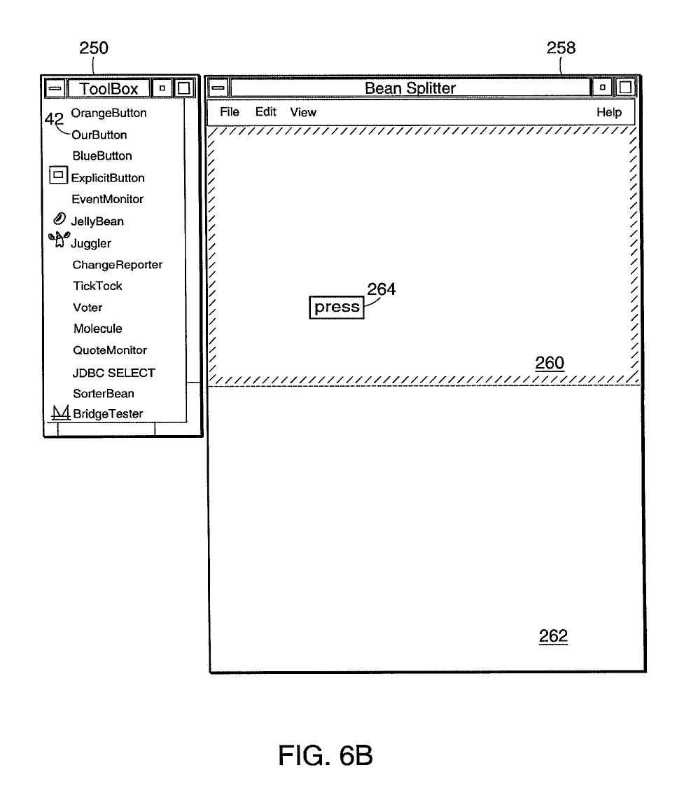

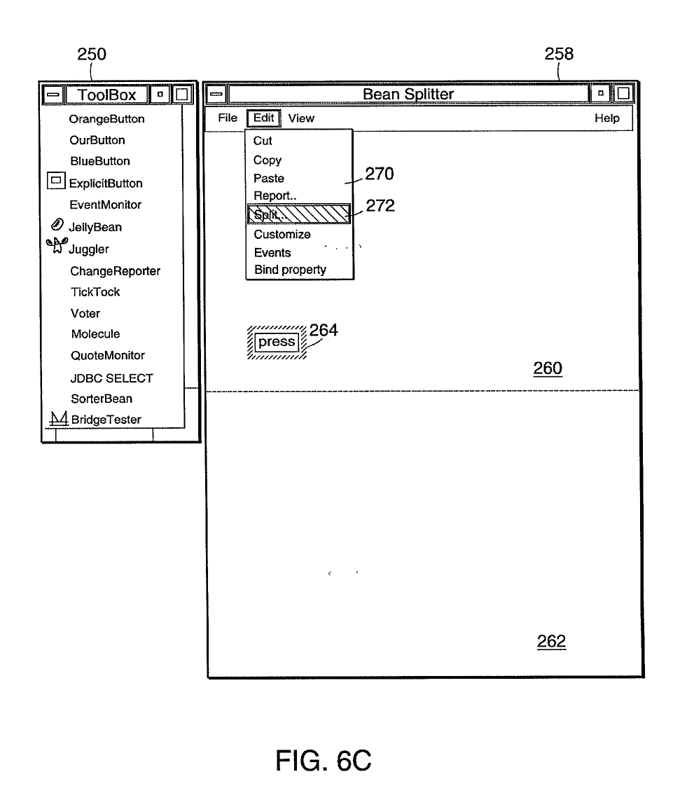

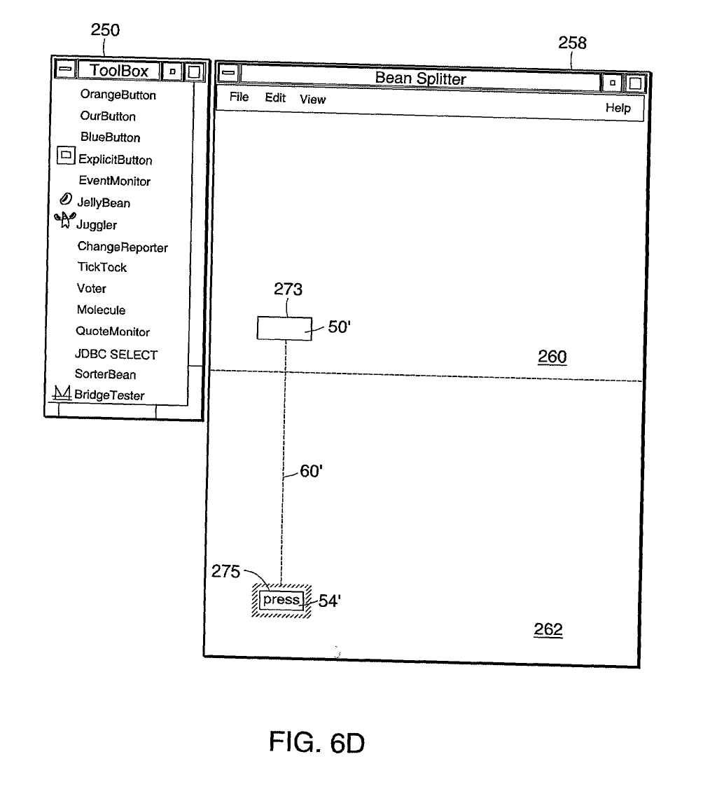

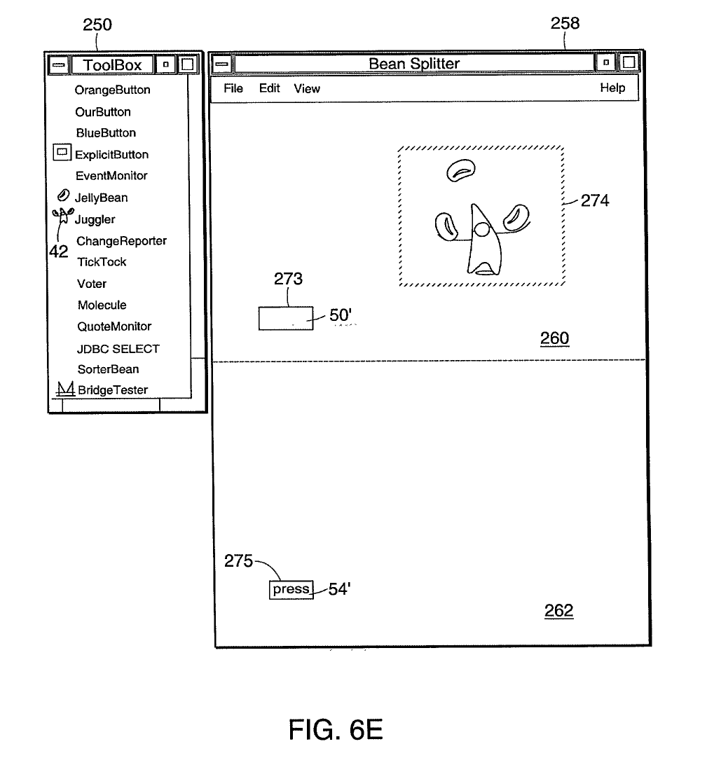

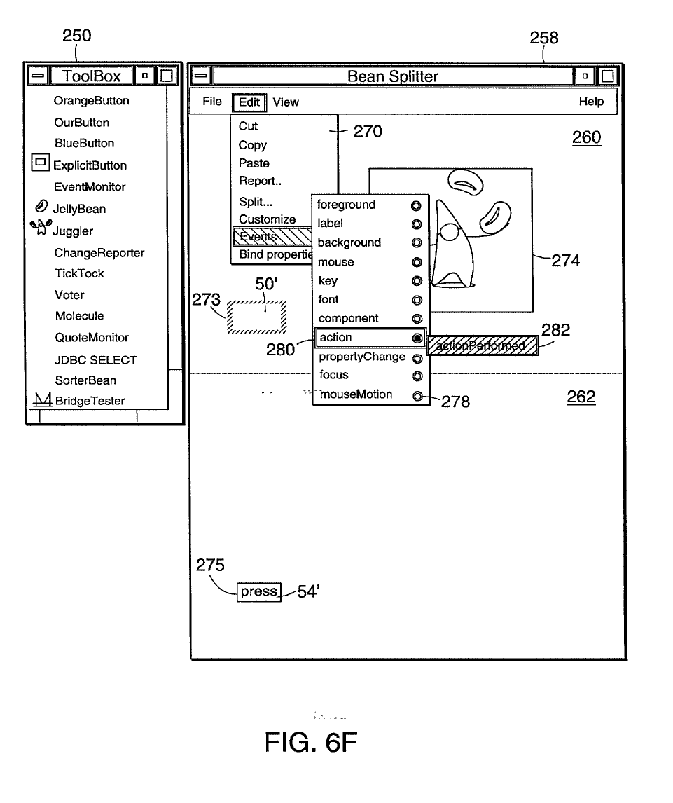

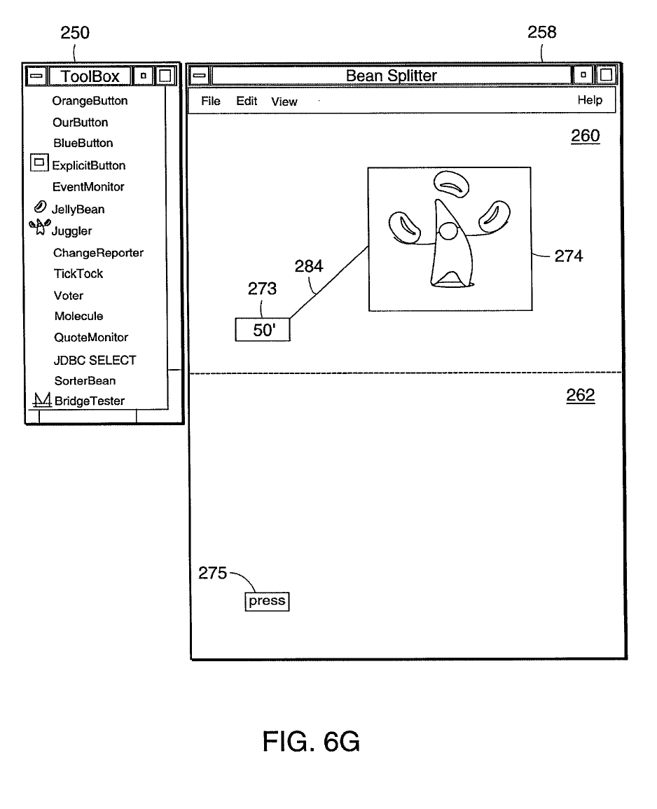

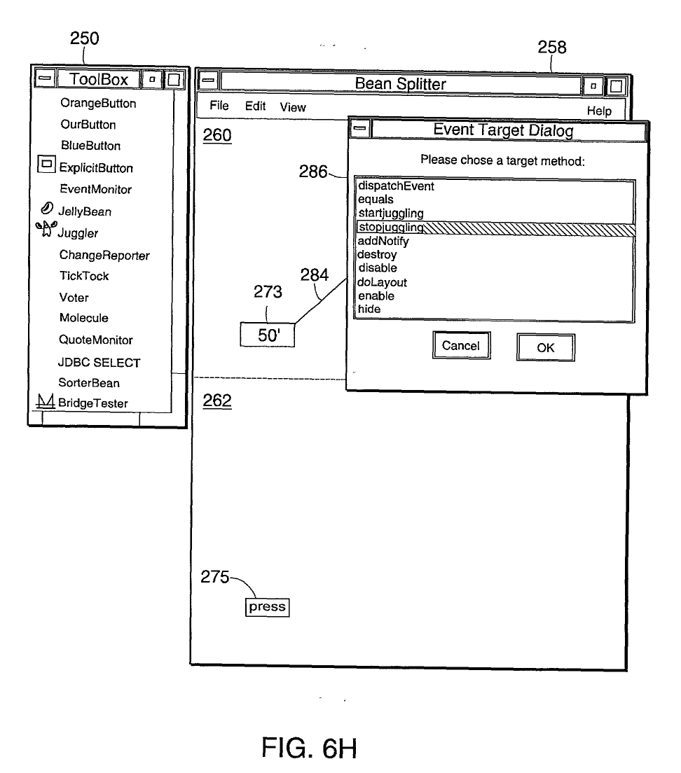

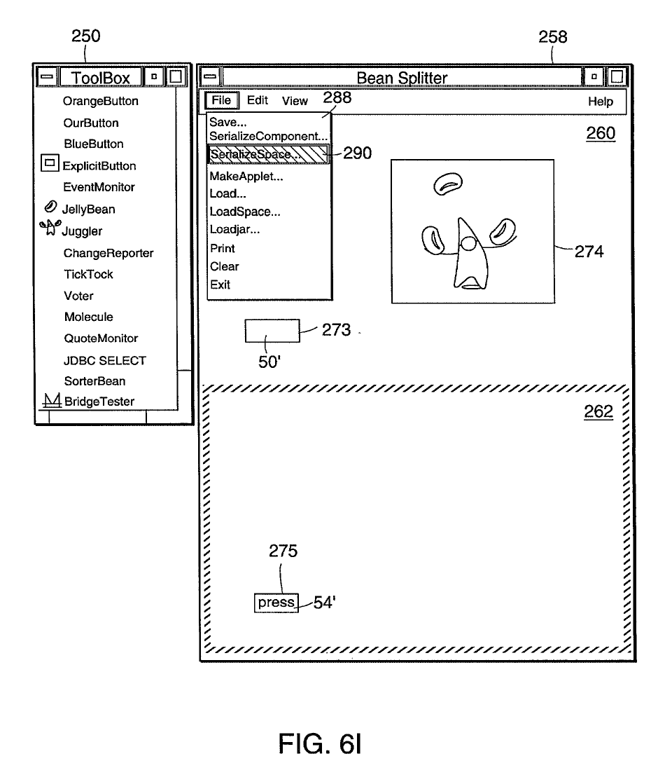

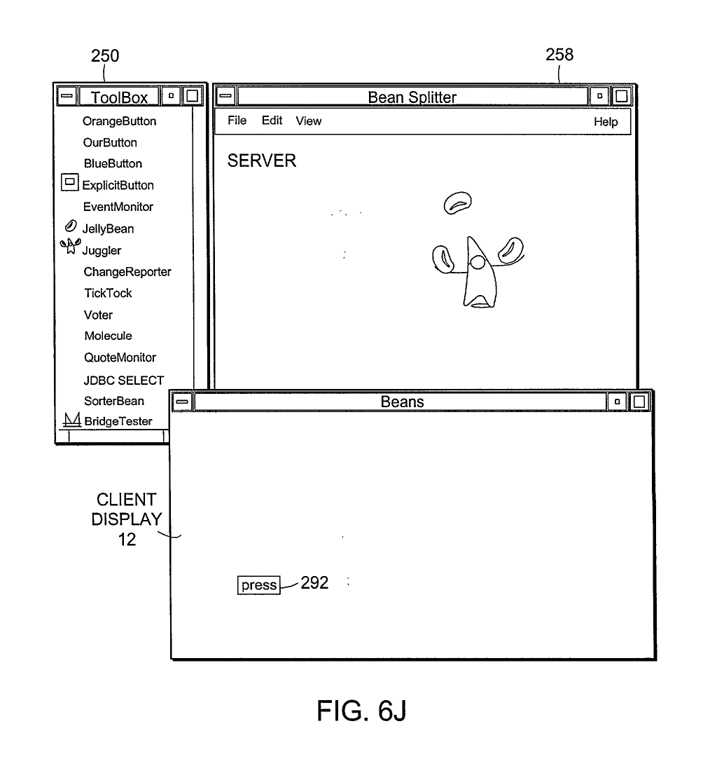

FIGS. 6A-6J shows a exemplary sequence of displays that the application program developer views during the construction of an application program using an embodiment of the application builder tool 18 that incorporates the software component splitter 44′, as described above. This embodiment of the application builder tool 18 is based on a modified version of the Beans Development Kit produced by JAVASoft™ of Mountain View Calif. Each display includes the component pallet 250 (referred to as the Tool Box) and the design region 258 (labeled Bean Splitter). The design region 258 is a modified version from the JAVASoft Bean Box, modified to be split into two distinct regions representing the client-server split.

FIG. 6A shows an example of a display presented to the application program developer including the Tool Box 250, having a list of available software components 42, and the Bean Splitter 258, having the server system design region 260 (outlined) and the client system design region 262. To instantiate one of the software components 42, the application program developer clicks on the desired software component 42 in the Tool Box 250, and then clicks in the server system design region 260 of the Bean Splitter window 258. FIG. 6B shows an example of the visual result 264 of instantiating the “OurButton” software component 42, which is selected from the Tool Box 250 and dropped into the server system design region 260 of the Bean Splitter window 258.

FIG. 6C shows an example of a pull-down menu 270 that provides a list of operations that can be performed on the “OurButton” software component 42. The pulldown menu 270 includes a “split” operation 272, which invokes the software component splitter 44′ when selected by the application program developer. The “split” operation 272 and the visual representation 264 of the instantiated “OurButton” software component 42 are highlighted to indicate that the application program developer intends to partition the “OurButton” software component 42.

FIG. 6D shows an example of a display illustrating the results of the “split” operation 272. Splitting the selected “OurButton” software component 42 results in the generation of an application core software component 50′ and an application proxy software component 54′. A visual representation 273 of the application core software component 50′ appears in the server system design region 260, and a visual representation 275 of the application proxy software component 54′ appears in the client system design region 262. The software component splitter 44′ also generates a protocol 60′ (drawn in phantom) by which the software components 50′, 54′ communicate. It is to be understood that showing the components 50′, 54′ is intended as a visualization of the partitioning process. It may not be necessary or desirable to show the split to the software developer. A purpose of the modified IDE 18 is to reveal the operation of the software component splitter 44.

FIG. 6E shows an example of the visual result 274 of instantiating the “Juggler” software component 42, selected from the Tool Box 250 and dropped into the server system design region 260, which presently includes the application core software component 50′ generated from the instantiated “OurButton” software component 42.

FIG. 6F shows the pull-down menu 270 that provides a list of operations that can be performed on the instantiated software components visually represented in the server system design region 260. The pull-down menu 270 includes an “events” operation 276, which invokes a second pull-down menu 278 when selected by the application program developer. The second pull-down menu 278 lists various events that can be selected by the application program developer, including an “action” event 280. Selecting the “action” event 280 causes the selection of the “actionPerformed” 282, which positions a line under the mouse arrow. The application program developer uses the line to link the visual representation 273 of the application core software component 50′ to the visual representation 274 of the “Juggler” software component 42. The Juggler represents a non-Ul server logic component. The non-Ul component 50 is part of the application core 46 and only has a visual representation so that the application program developer can see its operation. FIG. 6G shows an example of the visual result of connecting a line 284 between the visual representation 273 of the application core software component 50′ and the visual representation 274 of the “Juggler” software component 42.

FIG. 6H shows an example of a dialog window (here, “EventTargetDialog”) that appears when the application program developer connects the line 284 between the visual representations 273, 274 of the application core and “Juggler” software components 50′, 42, respectively. In this example, the dialog window 286 lists those Juggler methods that either take no argument or take an argument of the type “actionPerformed”. A method selected from this dialog window 286 becomes associated with the application core software component 54′. Here, the method “stopjuggling” is selected and thus linked to the execution of the application core software component 54′.

FIG. 61 shows an example of a pull-down menu 288 that provides a list of various operations, including a “serialspace” operation 290, which exports the client user interface to the client system 10. FIG. 6J shows the user interface as it would appear on the client display screen 12 to the client user at the client system 10 as a result of exporting the user interface. Although the toolbox 250, server region 258, and client user interface are shown together in FIG. 6J, it is to be understood that the client system 10 typically does not include the IDE (and thus the toolbox 250) and would only show the client user interface. Further, the server system 20 would host the “Juggler” without its visual display, and typically does not have the IDE as well. The client user interface appears when the client user launches the “Beans” application program, which causes in one embodiment the client components 54 to be transmitted to the client 10. Pressing the button 292 displayed at the client system 10 causes the Juggler executing at the server system 20 to stop juggling. When the client user presses the button 292, the application proxy software component 54′ executes at the client system 10 and communicates with the application core software component 50′ across the network 30 using the dynamically generated protocol 60′. The application core software component 50′ invokes the “stopjuggling” method of the “Juggler” software component 42 executing on the server system 20 because of the link established between the software components 50′, 42 by the application program developer.

The present invention may be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPROM, an EPROM, a PROM, a RAM, a ROM, or a magnetic tape. Another example of an article of manufacture is the application builder tool 18 that incorporates a software component splitter 44′ in accordance with the principles of the invention. In general, any standard or proprietary, programming or interpretive language can be used to produce the computer-readable software programs. Examples of such languages include C, C++, Pascal, JAVA, BASIC, VISUAL BASIC, and Visual C++. The software programs may be stored on or in one or more articles of manufacture as source code, object code, interpretive code or executable code.

While the invention has been shown and described with reference to specific preferred embodiments, it should be understood by those skilled in the art that various changes in form and detail may be made therein without departing from the spirit and scope of the invention as defined by the following claims. For example, in other embodiments, software components can be partitioned into more than two corresponding software components, with the corresponding software components being interconnected with a group communications protocol. Further, application core software components can have multiple corresponding application proxy software components to provide shared viewing (as used in groupware applications). Also, the application core and application proxy software components can be replicated for fault tolerance or for increased availability.

What is claimed is:

1. In a network including a client system in communication with a server system hosting an application program written for execution as a single program unit and including software components, a method of executing the application program comprising:
identifying one or more of the software components of the application program as a candidate for partitioning;
generating at the server system a plurality of new software components corresponding to one of the identified software component candidates;
generating a protocol to be used by the new software components to communicate with each other during an execution of the application program; and
transmitting one of the plurality of new software components to the client system for execution at the client system, the new software component transmitted to the client system communicating with one of the other of the plurality of new software components at the server system using the generated protocol when the application program is executed.

2. The method of claim 1 further comprising wrapping the identified software component candidate in one of the new software components generated at the server system.

3. The method of claim 2 further comprising migrating the wrapped software component from one generated new software component to another generated new software component over the network.

4. The method of claim 2 wherein the identified software component candidate is wrapped in the new software component that is transmitted to the client system for execution.

5. The method of claim 4 wherein the new software components communicate with each other using a component protocol.

6. The method of claim 2 wherein the identified software component is wrapped in a new software component at the server system for execution at the server system.

7. The method of claim 6 wherein the new software components communicate with each other using an object protocol.

8. The method of claim 1 further comprising including in the identified software component candidate a description that facilitates identification of that software component as a candidate for partitioning.

9. The method of claim 1 wherein the step of identifying the software component as a candidate for partitioning includes determining that such software component has a software element that relates to a user interface.

10. The method of claim 9 wherein the software element is an external interface of the identified software component candidate.

11. The method of claim 1 wherein the step of generating the plurality of software components corresponding to the identified software component candidate includes replicating external interfaces of the identified software component candidate for inclusion in each generated new software component.

12. The method of claim 1 wherein the steps of identifying one of the software components as a candidate for partitioning, generating the plurality of corresponding software components, and generating the protocol occur at run time of the application program.

13. The method of claim 1 further comprising analyzing the identified software component candidate to determine whether to execute the identified software component candidate at the server system rather than partition the identified software component candidate for execution at the client system.

14. In a network including a client system in communication with a server system, a method of partitioning a software component for dividing execution of the software component between the client and server systems, the method comprising:
analyzing a first software component to determine whether the first software component is to be partitioned;
if the first software component is to be partitioned:
(a) dynamically generating a plurality of new software components corresponding to the first software component and a protocol to be used by the dynamically generated new software components for communicating with each other, and (b) transmitting one of the dynamically generated new software components to the client system for execution at the client system and for communication with another of the generated new software components at the server system using the dynamically generated protocol;
otherwise, executing the first software component at the server and communicating with the client system using a remote graphics protocol.

15. The method of claim 14 further comprising determining, if the first software component is to be partitioned, whether the first software component is to execute on the client system.

16. The method of claim 15 wherein the dynamically generated protocol is a component protocol when the first software component is to execute at the client system.

17. The method of claim 15 wherein the dynamically generated protocol is an object protocol when the first software component is to execute at the server system.

18. The method of claim 15 further comprising providing an integrated development environment in which to analyze the first software component to determine whether the first software component is to be partitioned and to partition the first software component if the first software component is to be partitioned.

19. In a network including a client system in communication with a server system, a method of executing an application program comprised of a user-interface software component and a non-user-interface software component, the method comprising:
(a) generating a plurality of new software components corresponding to the user-interface software component of the application program;
(b) wrapping the user-interface software component with one of the new software components;
(c) transmitting one of the new software components to the client system;
(d) communicating with the new software component at the client system using a dynamically generated protocol when the user-interface software component is executed; and
(e) communicating with the client system using a remote graphics protocol when the non-user-interface software component is executed.

20. The method of claim 19 further comprising determining whether to execute the user-interface software component at the client system, and wherein the dynamically generated protocol is a component protocol if the user-interface component is to be executed at the client system.

21. The method of claim 19 wherein the dynamically generated protocol is an object protocol if the user-interface component is to be executed at the server system.

22. The method of claim 19 further comprising building an application program comprised of the new software components using an integrated development environment.

23. In a computer network, a computer system hosting an application program, the computer system comprising:
a software component analyzer identifying a first one of the software components of the application program as a candidate for partitioning;
a software component generator generating a plurality of new software components corresponding to the identified software component candidate and a protocol to be used by the new software components for communicating with each other over the network; and
a transmitter transmitting one of the new software components to a client system over the network for execution at the client system and for communication with another of the new software components at the computer system using the generated protocol when the application program is executed.

24. The computer system of claim 23 wherein a predetermined criterion for identifying the first software component as a candidate for partitioning is that the software component includes a user-interface element.

25. The computer system of claim 23 wherein the first one of software components identified as a candidate is a JAVA Bean.

26. The computer system of claim 23 wherein one of the new software components generated at the server system wraps the first one of software components identified as a candidate for partitioning.

27. The computer system of claim 26 wherein the new software component that wraps the identified software component candidate is the new software component that is transmitted to the client system for execution.

28. The computer system of claim 27 wherein the generated protocol is a component protocol.

29. The computer system of claim 26 wherein the new software component that wraps the identified software component candidate remains at the server system for execution at the server system.

30. The computer system of claim 29 wherein the generated protocol is an object protocol.

31. The computer system of claim 23 wherein the identified software component candidate includes a description that facilitates identification of the first one of the software components as a candidate for partitioning.

32. The computer system of claim 23 wherein each generated new software component corresponding to the identified software component candidate includes a copy of the external interfaces of the identified software component candidate.

33. An application builder tool for providing an integrated development environment in which to construct an application program, the application builder tool comprising:
a software component pallet listing a plurality of software components that are available for selection by an application program developer in constructing an application program; and
a software component splitter generating a plurality of new software components from one of the software components listed by the software component pallet, one of the new software components being generated for execution on a client system and another of the new software components being generated for execution on a server system, the splitter generating a protocol to be used by the new software components to communicate with each other.
